(19) United States
(12) Patent Application Publication
(10) Pub. No.: US 2017/0197720 A1
(43) Pub. Date: Jul. 13, 2017

(54) INFLATABLE AIRCRAFT MATTRESS

(71) Applicant: Berge Raymond Kiraz, Silver Spring, MD (US)

(72) Inventor: Berge Raymond Kiraz, Silver Spring, MD (US)

(21) Appl. No.: 14/994,984

(22) Filed: Jan. 13, 2016

(51) Int. Cl. B64D 11/00; A47C 27/08; A47C 27/10; A47D 15/00

(52) U.S. Cl. CPC B64D 11/00; A47D 15/001; A47C 27/081; A47C 27/10; B64D 2011/0069

(57) ABSTRACT

An inflatable aircraft mattress comprising an inflatable mattress section having a first chamber, the mattress section capable of being longitudinally aligned on an aircraft seat, the mattress section having a top sleeping surface; an inflatable base section having a second chamber, the base section vertically aligned on a front portion of the aircraft seat, the base section including two opposite non-inflatable wall sections; an inflatable height adjustment section having a third chamber, the height adjustment section is attached to the base section; a plurality of inflation valves positioned on the inflatable aircraft mattress enabling air to enter the first, second, and third chamber; a plurality of deflation valves positioned on the inflatable aircraft mattress enabling air to exit the first, second, and third chamber.

### CROSS-REFERENCE TO RELATED APPLICATIONS

N/A

### BACKGROUND OF THE INVENTION

Field of the Invention

The present invention relates to inflatable mattresses for use in vehicles. More particularly, the present invention relates to an inflatable aircraft mattress for infants, babies, and toddlers.

Description of Related Art

In the art of traveling with an infant, baby, or toddler it is often a stressful situation for the parent or guardian traveling with the child. The best scenario is creating an environment that is beneficial to both the child and the parent. Presently, if a child is under two years of age, an additional purchased seat for the child is not required, as they are allowed to sit on the parent's lap during travel. However, this scenario is not necessarily ideal as the child is forced to occupy a small space, and the parent will not have a hands free experience during the duration of the flight. This scenario becomes more difficult as the flight duration increases.

One possibility is carrying a car seat on the flight and installing it on a seat in the aircraft, allowing the parent to have a hands free experience during the flight. However, there are many disadvantages to bringing a car seat on the flight. Car seats are often heavy, bulky and difficult to carry. Furthermore, installing a car seat is not always a seamless process and once installed the car seat is in an upright position which is not necessarily conducive for long comfortable hours of sleep, necessary for the infant/toddler and good for the parent/guardian.

Consequently, there is a need for solution that allows a child to rest or sleep long comfortable hours easily during travel on an aircraft, which is simple to install, without disturbing others around you, while being compact and light for ease of carrying.

### BRIEF SUMMARY OF THE INVENTION

Such stated summary and advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

In one embodiment of the present invention an inflatable aircraft mattress is provided comprising an inflatable mattress section having a first chamber, the mattress section capable of being longitudinally aligned on an aircraft seat, the mattress section having a sleeping surface; an inflatable base section having a second chamber, the base section vertically aligned on a front portion of the aircraft seat, the base section including two opposite non-inflatable wall sections; an inflatable height adjustment section having a third chamber, the height adjustment section is attached to the base section; a plurality of inflation valves positioned on the inflatable aircraft mattress enabling air to enter the first, second, and third chamber; a plurality of deflation valves positioned on the inflatable aircraft mattress enabling air to exit the first, second, and third chamber.

In one embodiment, the mattress section rests perpendicularly on the base section. In another embodiment, the mattress section and base section are removably attached via a pair of attachment straps preventing the mattress section from shifting during use. In one embodiment, the sleeping surface is waterproof and constructed from a flock material, including but not limited to flocked polyvinyl chloride and flocked fleece. In one embodiment, the mattress section includes at least one support beam laterally positioned across the base section in the first chamber. In another embodiment, the at least one support beam includes at least one arch tunnel allowing air to pass through. In yet another embodiment, the at least one support beam is construed from foam designed to support the weight of a child resting on the sleeping surface.

In one embodiment the mattress section is constructed from a puncture resistance heavy-gauge material, including but not limited to polyvinyl chloride and vinyl. In one embodiment, the wall sections include a layer of rigid foam designed to reinforce and stabilize the base section. In another embodiment, the aircraft seat is adjacent to an aircraft window. In one embodiment, the mattress section includes a pair of safety straps designed to secure a child on the sleeping surface during travel. In yet another embodiment, the present invention further comprises at least one securing strap adapted to engage an existing seatbelt on the aircraft seat such that the inflatable aircraft mattress is secured to the aircraft seat. In one embodiment, the height adjustment chamber is a leveling tool to increase the height of the base section to align the mattress section with the aircraft seat.

In another aspect of the invention, an inflatable aircraft mattress is provided comprising an inflatable mattress section having a first chamber, the mattress section capable of being longitudinally aligned on an aircraft seat, the mattress section having a sleeping surface; an inflatable base section having a second chamber, the base section vertically aligned on a front portion of the aircraft seat; a plurality of valves positioned on the inflatable aircraft mattress enabling air to enter and exit the first and second chamber.

In one embodiment, the present invention further comprises an inflatable height adjustment section having a third chamber. In one embodiment, the height adjustment section is attached to the base section. In another embodiment, the height adjustment chamber is a leveling tool to increase the height of the base section to align the mattress section with the aircraft seat. In yet another embodiment, the mattress section and base section are removably attached via a pair of attachment straps preventing the mattress section from shifting during use.

In another aspect of the invention an inflatable aircraft mattress is provided comprising an inflatable, rectangular shaped mattress section having a first chamber, the mattress section capable of being longitudinally aligned on an aircraft seat, the mattress section including at least one foam support beam laterally positioned across the base section in the first chamber, the mattress section having a sleeping surface; an inflatable, rectangular shaped base section having a second chamber, the base section vertically aligned on a front portion of the aircraft seat, the base section including two opposite non-inflatable rigid foam wall sections; the mattress section rests perpendicularly on the base section, and the mattress section and base section are removably attached via a pair of attachment straps preventing the mattress section from shifting during use; an inflatable height adjustment section having a third chamber, the height adjustment section is attached to the base section; a plurality of inflation valves positioned on the inflatable aircraft mattress enabling air to enter the first, second, and third chamber; a plurality of deflation valves positioned on the inflatable aircraft mattress enabling air to exit the first, second, and third chamber.

### BRIEF DESCRIPTION OF THE SEVERAL VIEWS OF THE DRAWINGS

It is to be understood that the drawings are to be used for the purposes of exemplary illustration only and not as a definition of the limits of the invention.

Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding part(s) throughout:

FIG. 1 is an exemplary perspective view illustrating an inflatable aircraft mattress according to an embodiment of the present invention.

FIG. 2 is an exemplary detailed view illustrating an inflatable aircraft mattress installed on an aircraft seat according to an embodiment of the present invention.

FIG. 3 is an exemplary side perspective view illustrating an inflatable aircraft mattress installed on an aircraft seat according to an embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

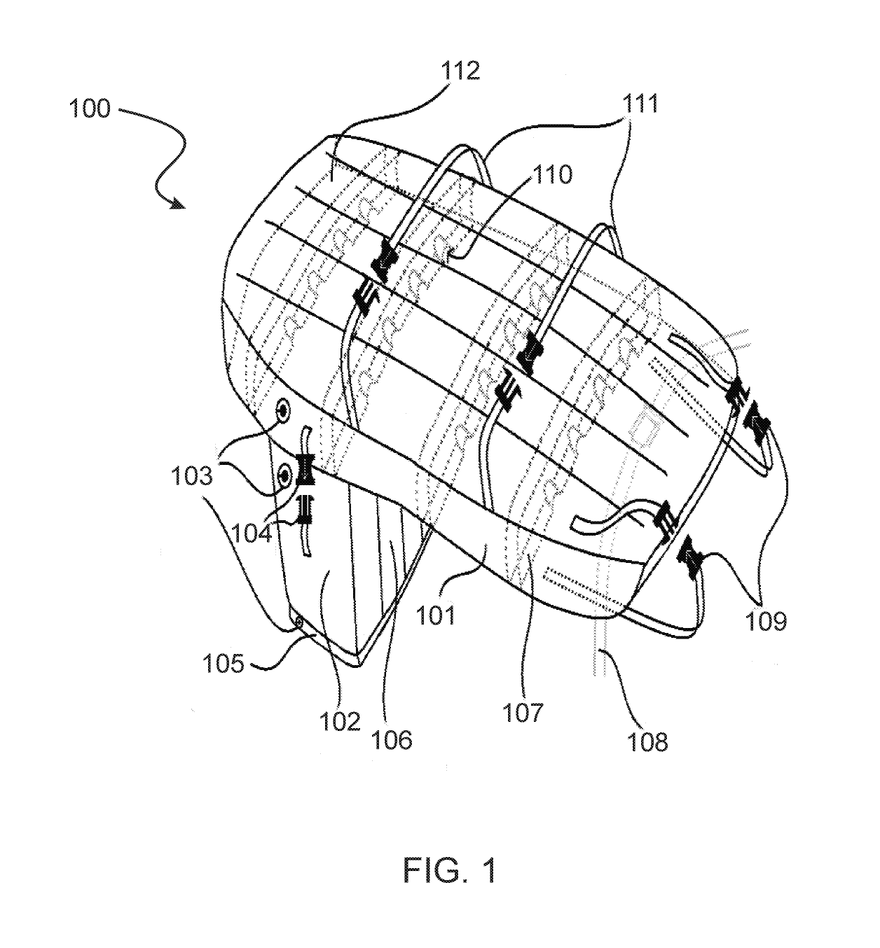

FIG. 1 is an exemplary perspective view illustrating an inflatable aircraft mattress 100 according to an embodiment of the present invention. Referring now to FIG. 1, the inflatable aircraft mattress comprises a horizontal top section 101 including a top surface. The horizontal top section is a substantially rectangular shaped single inflatable air chamber constructed from polyvinyl chloride (PVC), vinyl, or similar heavy-gauge puncture resistant material. The top surface of the horizontal top section is where an infant, toddler, or baby would lie down, rest, or sleep during a flight. The top surface is constructed from a flocked material, including but not limited to flocked PVC or flocked fleece. To provide easy cleaning, the top surface is waterproof in case of any accidental spills. For convenience, the size of the horizontal top section is similar to a standard king size pillow allowing the use of a standard king size pillow case as a bed sheet during use. The horizontal top section measures approximately 33 inches in length and approximately 17 inches in width. The pillow case would have to be modified to allow a number of securing straps 109/111 to pass through. Likewise, a specific pillow case designed for the inflatable aircraft mattress with precut passageways for the securing straps may be provided. The securing straps will be discussed in greater detail below.

Still referring to FIG. 1, the inflatable aircraft mattress comprises a vertical bottom section 102 including two non-inflatable surface walls 106 and a height adjustment chamber 105. The vertical bottom section is a rectangular shaped single inflatable air chamber surrounded by the surface walls. The surface walls are located at the front and back of the vertical bottom section and are constructed from a thin layer of rigid foam approximately ¾″ thick. The surface walls provide support to the vertical bottom section and help reduce the amount of air needed to inflate the second single inflatable air chamber resulting in less time needed to inflate.

A plurality of inflate valves 103 are provided on the horizontal top section, the vertical bottom section, and the height adjustment chamber. The plurality of inflate valves are one way valves, so no air is lost while inflating. In some embodiments, a plurality of air release valves (not illustrated) located on opposites sides of the plurality of inflate valves on the horizontal top section, the vertical bottom section, and the height adjustment chamber are provided to allow a user to quickly deflate the inflatable aircraft mattress.

In operation, horizontal top section 101 and vertical bottom section 102 are inflated independently, and then secured together by a pair of connection straps 104. The connection straps are located on opposite sides of the inflatable aircraft mattress. Specifically, the horizontal top section and the vertical bottom section are inflated, and then the horizontal top section is placed on the vertical bottom section as illustrated. Next, the pair of connection straps is used to secure the horizontal top section to the vertical bottom section preventing the horizontal top section from shifting of the vertical bottom section during use. Once installed, the vertical bottom section supports the horizontal top section, and the thin layer of rigid foam allows the support to be firm rather than spring like.

Since the inflatable aircraft mattress needs to be installed and inflated in an airplane seat with limited space, having independent sections helps for ease of installation rather than one complete unit.

In some embodiments, the horizontal top section comprises a plurality of airbed supports 107. The airbed supports are configured in a predetermined arrangement across the horizontal top section spaced at equal distances from each other. The plurality of airbed supports are constructed from foam and each support is approximately 1½″ wide. The plurality of airbed supports help support the weight of an infant, toddler, or baby during use. The airbed supports add volume to the horizontal top section, minimizing the amount of air needed to inflate corresponding to a faster inflate time leading to an easier installation process. Likewise, when the horizontal top section is deflated, the plurality of airbed supports will be compressed on next to each other, allowing the horizontal top section to be folded and stored easily when not in use. When mattress 100 is deflated, it can be folded to fit into a standard seized backpack for transportation.

In some embodiments, each of the plurality of airport supports have a number of arched tunnels 110 located at the bottom along on the entire airbed support. The arched tunnels allow air to pass through them, maintaining a single chamber design as described above.

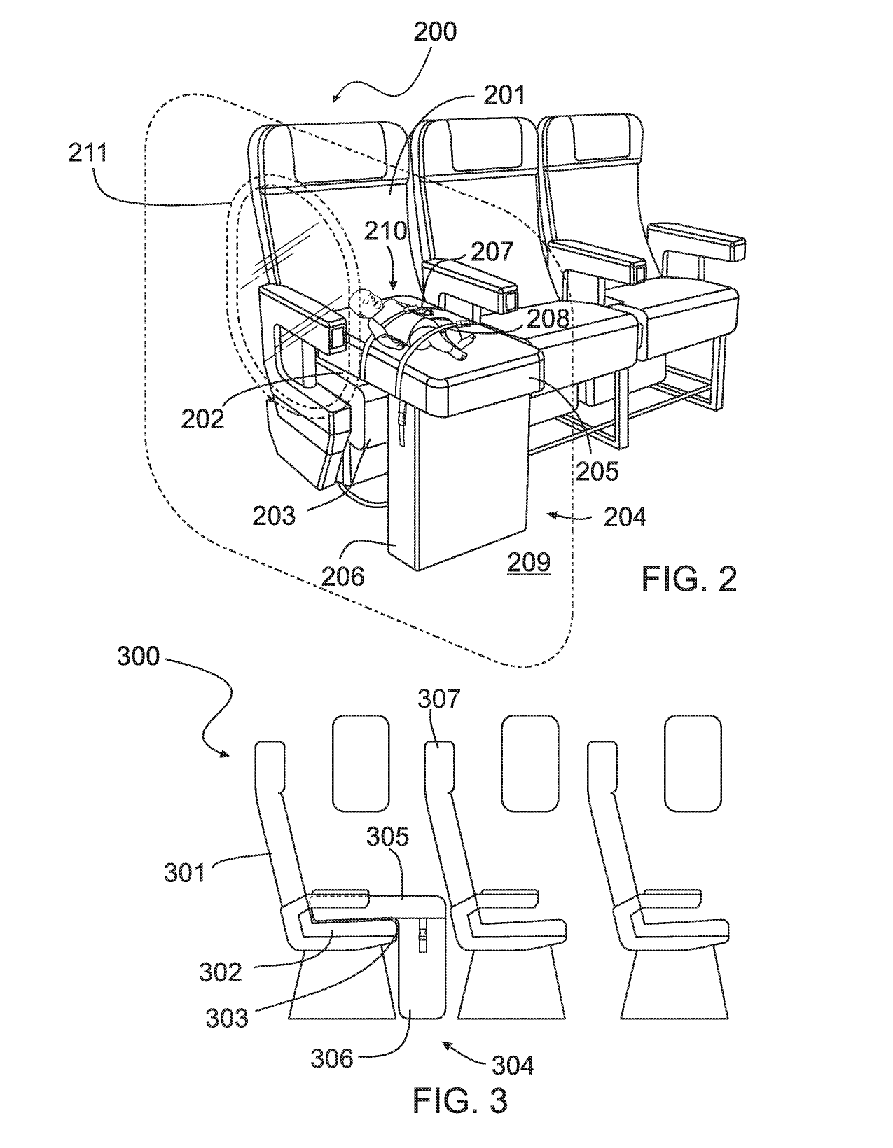

During the installation process, existing airplane seatbelt 108 is fastened and tightened as much as possible, as well known in the art. The horizontal top section rests longitudinally over the existing airplane seatbelt, then securing straps 109 are used to secure the inflatable aircraft mattress to an airplane seat 200 (FIG. 2). The securing straps are adjustable, and are designed to go under the existing airplane seatbelt before being clicked in a closed position securing and holding down the inflatable aircraft mattress to the airplane seat.

In some embodiments, safety straps 111 are used to safely keep the infant, toddler, or baby secured to the inflatable aircraft mattress during travel. This will be discussed in greater detail below.

FIG. 2 is an exemplary detailed view illustrating an inflatable aircraft mattress 204 installed on an aircraft seat 200 according to an embodiment of the present invention. Referring now to FIG. 2, the aircraft seat comprises a seat back 201, seat cushion 202, and front portion 203. The inflatable aircraft mattress comprises horizontal top section 205 and vertical bottom section 206. The horizontal top section abuts the seat back and rests on the seat cushion. The vertical bottom section abuts the front portion of the aircraft seat and rests on a floor surface 209 of the aircraft while supporting the horizontal top section as discussed previously. During travel, an infant, toddler, or baby 210 is positioned on the horizontal top section and secured by safety straps 207/208. The safety straps are adjustable to accommodate the size of the traveler.

The inflatable aircraft mattress is designed to be installed on the aircraft seat adjacent to an aircraft window 211. This allows the inflatable aircraft mattress to remain installed during travel without the need to be deflated to permit passengers a passageway to the isle of the aircraft. Understandably, this requires an additional aircraft seat to be purchased, or use of an empty seat, if available, for the flight, as opposed to a lap infant arrangement as well known in the art. However once the infant, toddler, or baby is safely strapped into the inflatable aircraft mattress, the parent or guardian has the use of both hands and access to the space in front of them including the tray table.

FIG. 3 is an exemplary side perspective view illustrating an inflatable aircraft mattress 304 installed on an aircraft seat 300 according to an embodiment of the present invention. Referring now to FIG. 3, the aircraft seat comprises a seat back 301, seat cushion 302, and front portion 303. The inflatable aircraft mattress comprises horizontal top section 305 and vertical bottom section 306. The exemplary side perspective view allows for perspective on the amount of space the inflatable aircraft mattress takes up, and specifically how the horizontal top section extends nearly to the back of an aircraft seat 307 located directly in front of the aircraft seat the inflatable aircraft mattress is presently installed.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, a computer may be used to control the operation of the apparatus, including programming the predetermined time and compressed air pressure, as well as activating the air trigger automatically. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

Further, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. An inflatable aircraft mattress comprising:
an inflatable mattress section having a first chamber, the mattress section capable of being longitudinally aligned on an aircraft seat, the mattress section having a top surface;
an inflatable base section having a second chamber, the base section vertically aligned on a front portion of the aircraft seat, the base section including two opposite non-inflatable wall sections;
an inflatable height adjustment section having a third chamber, the height adjustment section is attached to the base section;
a plurality of inflation valves positioned on the inflatable aircraft mattress enabling air to enter the first, second, and third chamber;
a plurality of deflation valves positioned on the inflatable aircraft mattress enabling air to exit the first, second, and third chamber.

2. The inflatable aircraft mattress of claim 1, wherein the mattress section rests perpendicularly on the base section.

3. The inflatable aircraft mattress of claim 1, wherein the mattress section and base section are removably attached via a pair of attachment straps preventing the mattress section from shifting during use.

4. The inflatable aircraft mattress of claim 1, wherein the top surface is waterproof and constructed from a flock material, including but not limited to flocked polyvinyl chloride and flocked fleece.

5. The inflatable aircraft mattress of claim 1, wherein the mattress section includes at least one support member laterally positioned across the base section in the first chamber.

6. The inflatable aircraft mattress of claim 5, wherein the at least one support member includes at least one arch tunnel allowing air to pass through.

7. The inflatable aircraft mattress of claim 5, wherein the at least one support member is construed from foam designed to support the weight of a child resting on the sleeping surface.

8. The inflatable aircraft mattress of claim 1, wherein the mattress section is constructed from a puncture resistant heavy-gauge material, including but not limited to polyvinyl chloride and vinyl.

9. The inflatable aircraft mattress of claim 1, wherein the wall sections include a layer of rigid foam designed to reinforce and stabilize the base section.

10. The inflatable aircraft mattress of claim 1, wherein the aircraft seat is adjacent to an aircraft window.

11. The inflatable aircraft mattress of claim 1, wherein the mattress section includes a pair of safety straps designed to secure a child on the top surface during travel.

12. The inflatable aircraft mattress of claim 1, further comprising at least one securing strap adapted to engage an existing seatbelt on the aircraft seat such that the inflatable aircraft mattress is secured to the aircraft seat.

13. The inflatable aircraft mattress of claim 1, wherein the height adjustment chamber is a leveling tool to increase the height of the base section to align the mattress section with the aircraft seat.

14. The inflatable aircraft mattress of claim 1, wherein the mattress section measures approximately 33 inches in length and approximately 17 inches in width.

15. An inflatable aircraft mattress comprising:
an inflatable mattress section having a first chamber, the mattress section capable of being longitudinally aligned on an aircraft seat, the mattress section having a sleeping surface;
an inflatable base section having a second chamber, the base section vertically aligned on a front portion of the aircraft seat;
a plurality of valves positioned on the inflatable aircraft mattress enabling air to enter and exit the first and second chamber.

16. The inflatable aircraft mattress of claim 15, further comprising an inflatable height adjustment section having a third chamber.

17. The inflatable aircraft mattress of claim 16, wherein the height adjustment section is attached to the base section.

18. The inflatable aircraft mattress of claim 17, wherein the height adjustment chamber is a leveling tool to increase the height of the base section to align the mattress section with the aircraft seat.

19. The inflatable aircraft mattress of claim 15, wherein the mattress section and base section are removably attached via a pair of attachment straps preventing the mattress section from shifting during use.

20. An inflatable aircraft mattress comprising:
an inflatable, substantially rectangular shaped mattress section having a first chamber, the mattress section capable of being longitudinally aligned on an aircraft seat, the mattress section including at least one foam support member laterally positioned across the base section in the first chamber, the mattress section having a top sleeping surface;
an inflatable, rectangular shaped base section having a second chamber, the base section vertically aligned on a front portion of the aircraft seat, the base section including two opposite non-inflatable rigid foam wall sections;
the mattress section rests perpendicularly on the base section, and the mattress section and base section are removably attached via a pair of attachment straps preventing the mattress section from shifting during use;
an inflatable height adjustment section having a third chamber, the height adjustment section is attached to the base section,
a plurality of inflation valves positioned on the inflatable aircraft mattress enabling air to enter the first, second, and third chamber;
at least one deflation valve positioned on the inflatable aircraft mattress enabling air to exit the first, second, and third chamber.
